(19) United States
(12) Patent Application Publication
(10) Pub. No.: US 2026/0064369 A1
(43) Pub. Date: Mar. 5, 2026

(54) OPTIMIZED HARDWARE IMPLEMENTATIONS FOR MONOTONIC, NON-DECREASING THRESHOLDING

(71) Applicant: XILINX, INC., San Jose, CA (US)

(72) Inventors: Yaman UMUROGLU, Stockholm (SE); Nicholas FRASER, Co. Dublin (IE); Thomas Bernd PREUSSER, Dresden (DE)

(21) Appl. No.: 18/818,704

(22) Filed: Aug. 29, 2024

(51) Int. Cl. G06F 7/60; G06F 5/01

(52) U.S. Cl. CPC G06F 7/602; G06F 5/012

(57) ABSTRACT

Embodiments herein describe generating non-linear thresholds which can be used, for example, in a quantization operation of a neural network layer. In one example, a compiler can receive a set of non-linear thresholds (e.g., rounded integer thresholds) and determine delta values indicating respective differences between two thresholds of the non-linear thresholds. Because the thresholds are non-linear, the delta values are also different. The compiler can calculate residual errors to represent the differences between the deltas with respect to a step size. Using these residual errors, an initial threshold value, a step size between the thresholds, the non-linear thresholds can be calculated as needed, instead of having to store the non-linear thresholds in memory.

### TECHNICAL FIELD

The embodiments presented herein relate to determining monotonic, non-decreasing threshold values for performing quantization in a neural network layer.

### BACKGROUND

Neural networks (NNs) are known for their large computational and memory requirements. Quantization of weights and activations to integers is commonly applied to decrease this cost, while keeping tensor-or channel-wise scaling factors in floating point to obtain higher accuracy.

Monotonic quantized activations with floating-point scale factors can be implemented using multi-thresholding operations in hardware. This avoids expensive floating-point arithmetic while preserving the accuracy benefits. However, this comes at a memory storage cost for threshold values that grows exponentially with the bit-width of the quantized activations.

### SUMMARY

One embodiment described herein is a system that includes one or more processors and memory configured to store a compiler. The compiler configured to perform an operation including providing non-linear thresholds associated with a quantization operation, selecting an initial threshold value for thresholding logic configured to perform the quantization operation, determining delta values indicating respective differences between two thresholds of the non-linear thresholds where at least two of the delta values are different, determining a step size from the delta values, determining residual errors between the delta values based on the step size, and transmitting the initial threshold value, residuals, and step size to the thresholding logic for performing the quantization operation.

One embodiment described herein is a non-transitory computer readable medium storing instructions that, when executed by a combination of one or more processors, cause the combination of one or more processors to perform an operation. The operation includes providing non-linear thresholds associated with a quantization operation, selecting an initial threshold value for thresholding logic configured to perform the quantization operation, determining delta values indicating respective differences between two thresholds of the non-linear thresholds where at least two of the delta values are different, determining a step size from the delta values, determining residual errors between the delta values based on the step size, and transmitting the initial threshold value, residuals, and step size to the thresholding logic for performing the quantization operation.

One embodiment described herein is a computing system that includes circuitry that includes thresholding logic configured to store an initial threshold value for the thresholding logic, store residual errors between delta values and a step size, the delta values indicating respective differences between two thresholds from a set of non-linear thresholds where at least two of the delta values are different, store the step size between the set of non-linear thresholds, calculate the set of non-linear thresholds using the initial threshold value, the residual errors, and the step size.

### BRIEF DESCRIPTION OF DRAWINGS

FIG. 1 illustrates a system for performing quantization using linear thresholds, according to one embodiment herein.

FIG. 2 illustrates a system for performing quantization using linear thresholds, according to one embodiment herein.

FIG. 3 illustrates a system for performing quantization using linear thresholds, according to one embodiment herein.

FIG. 4 illustrates a system for performing quantization using monotonic, non-decreasing thresholds, according to one embodiment herein.

FIG. 5 illustrates thresholding logic for sequentially calculating monotonic, non-decreasing thresholds, according to one embodiment herein.

FIG. 6 illustrates thresholding logic for calculating monotonic, non-decreasing thresholds for a binary search tree, according to an example.

FIG. 7 is a flowchart for determining values for calculating monotonic, non-decreasing thresholds for quantization, according to an example.

FIG. 8 is a block diagram of computing systems, according to an example.

### DETAILED DESCRIPTION

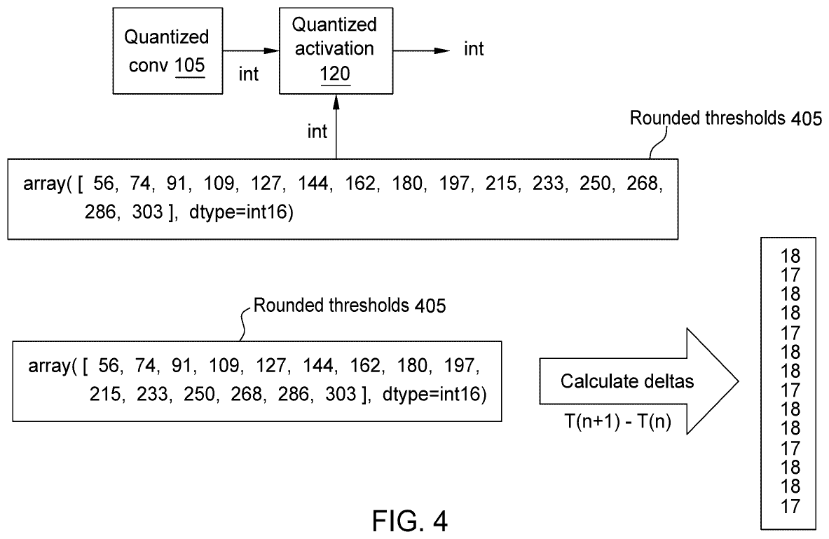

The embodiments herein exploit the near-uniform nature of monotonic, non-decreasing threshold values (particularly for the popular rectified linear unit (ReLU) activation function) which offers a significant decrease in required memory storage for hardware implementations of up to 32 times relative to storing the thresholds in memory. That is, while the thresholds are non-linear, they are near-uniform in that the difference (or delta) between the thresholds is similar. This is described in more detail in FIG. 4 below.

Rather than storing the thresholds, the embodiments herein can use thresholding logic which can calculate the thresholds using hardware. The thresholding logic can use an initial value (e.g., the first threshold, or a beginning threshold), a step value (e.g., a minimum delta or difference between the thresholds) and residuals which describe the error (or offset) between the minimum delta and an actual delta between thresholds. By storing these values in memory, the thresholding logic can calculate the thresholds as needed, thereby avoiding having to store the thresholds themselves.

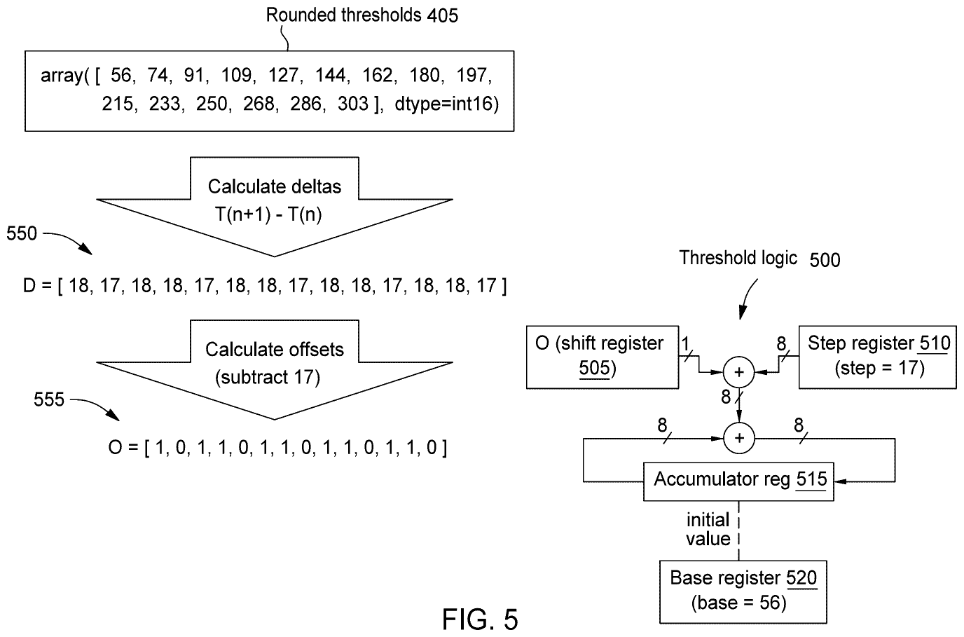

In one embodiment, these values can be used to determine the thresholds sequentially. In this case, the thresholding logic can use the initial value (e.g., the first threshold) and add the step value to it. And offset array can store the residual which can be used to correct or adjust the step value to the actual delta value. The thresholding logic can repeatedly calculate the next threshold until it grows beyond the input value or a predefined maximum. The logic can then return the index (or count) to the next layer in the neural network. An example of this thresholding logic is shown in FIG. 5.

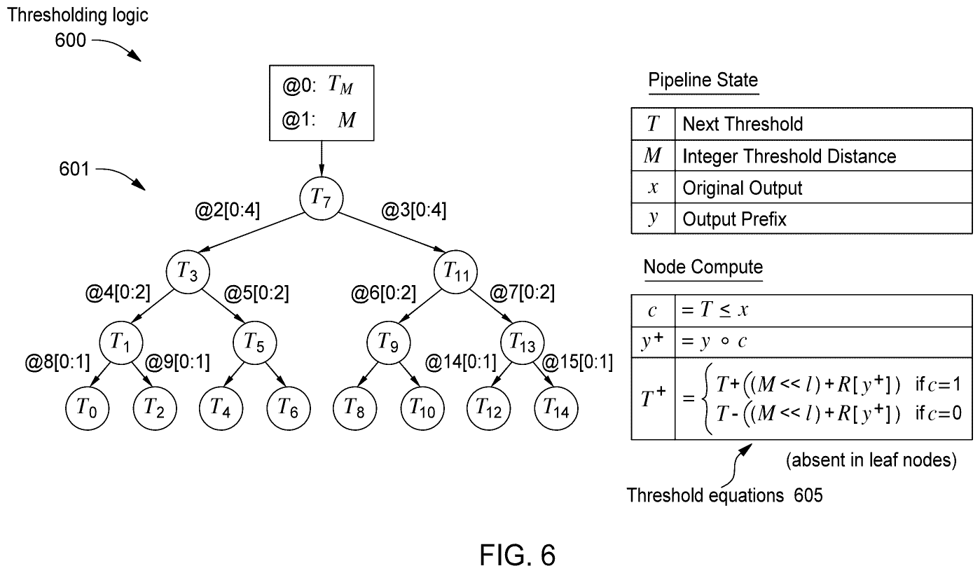

In another embodiment, the initial value, step value, and the residuals can be used in thresholding logic that implements a binary search tree. The first level of the tree can be the middle threshold (e.g., the seventh threshold assuming there are 15 thresholds). Depending on whether the input value is less than or not the middle threshold, the thresholding logic can use the step value, one of the residuals, and the current level of the binary tree to calculate the next threshold for the next level of the binary tree. Again, the output of the binary search can be the index of the threshold that is the closest bound to the value of the input with respect to the chosen ordering comparison. An example of this thresholding logic is shown in FIG. 6.

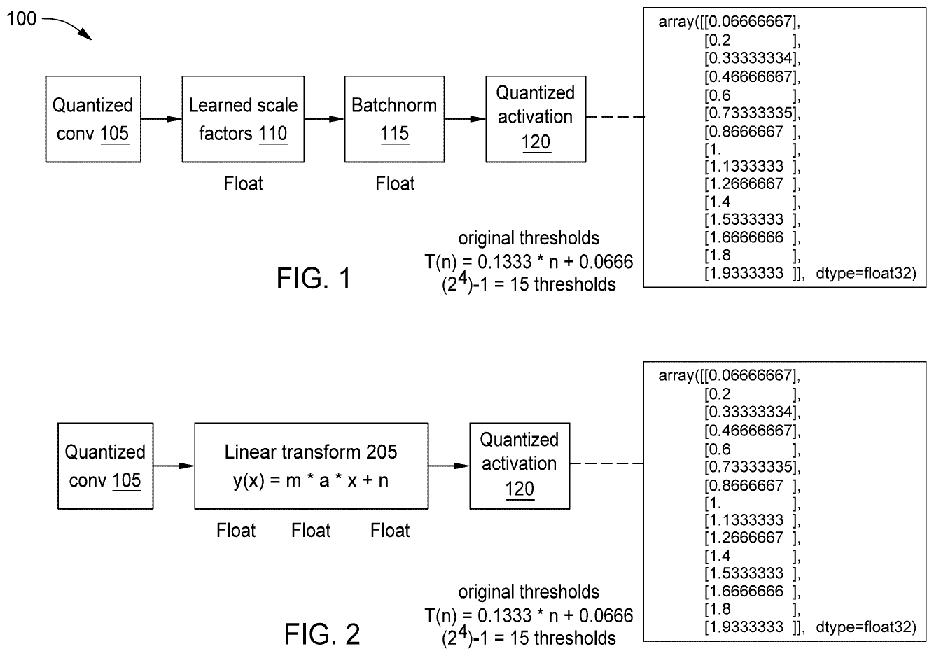

FIG. 1 illustrates a system 100 for performing quantization using linear thresholds, according to one embodiment herein. In one embodiment, the system 100 is part of a NN. However, the embodiments herein are not limited to a NN and may be used in any application which performs quantization, such as artificial intelligence or machine learning, signal processing, locality-sensitive hashing, and the like.

In FIG. 1, there are two layers of per-channel floating-point scaling factors: the scaling factors 110 learned for the convolutional layer weights of the quantized convolution (conv) layer 106, followed by the scaling introduced by a batch normalization (batchnorm) layer 115. The batchnorm layer 115 may also include an additive bias corresponding to a zero-point for quantization by the quantized activation layer 120. This pattern (Conv-BatchNorm-Activate) is common in convolutional neural networks (CNNs), especially with ReLU activations. There may be other layers introducing additional per-channel or per-tensor scaling factors and biases.

FIG. 1 also illustrates the thresholds that are used to perform the quantized activation layer 120. That is, the batchnorm layer 115 can generate a floating-point number which the quantized activation layer 120 then positions with respect to the thresholds. The number of thresholds can correspond to the number of desired output bits of the quantized activation layer 120. In the examples below, it is assumed that the desired output (k) is four bits. As such, the number of range-partitioning thresholds is not more than one less the total number of range segments differentiable by a k-bit index, i.e., 2\hat{ }4−1=15, where k as an unsigned index enumerating over the ranges/bins. The −1 in 2\hat{ }k−1 results from the fact that one gets n−1 dividers when an interval is split into n pieces. Thus, the quantized activation layer 120 takes any input from the batchnorm layer 115 and positions it (i.e., quantizes it) below, among or beyond the 15 thresholds.

At this stage, the thresholds can be represented by a linear function T(n). The actual values of the thresholds will depend on the training process for the NN, so the actual threshold values and functions shown in the following figures are just given for exemplary purposes and for facilitating the discussion.

The hardware can determine the thresholds in two ways. First, because at this point the quantization thresholds are linear, the hardware can include thresholding logic that can calculate the thresholds from the linear equation T(n)=0.1333 * n+0.0666. Alternatively, instead of calculating the thresholds, the 15 thresholds could be stored in memory in the hardware as floating-point values. Ideally, using an equation to generate the quantization thresholds rather than storing these thresholds may be preferred. Using k-bit quantized activations (e.g., the number of output bits from the activation layer 120) and a-bit inputs means ((2\hat{ }k)−1) * a * channels bits of storage are required. For instance, the thresholds for quantizing 8-bit activations from 24-bit inputs, typically coming from accumulators of convolutional or matrix-multiply layers, using 1024 channels would occupy 6,266,880 bits of storage. This is compounded when 32 bit floating-point activations are used as shown in FIG. 1. FIGS. 5-8 discuss techniques for avoiding having to store these quantization thresholds in memory.

FIG. 2 illustrates reducing the multiple layers of scaling factors of FIG. 1 into a single one. That is, FIG. 2 differs from FIG. 1 in that the float linear transforms have been collapsed into a single linear transform layer 205. At this point, the inference computation can be implemented by explicitly performing floating-point or fixed-point (under certain restrictions) multiply-add operations on the result of the quantized convolution.

The quantized activation layer 120 in FIG. 2 remains the same as in FIG. 1 in that the linear quantization thresholds can be represented by the same equation T(n) as introduced in FIG. 1.

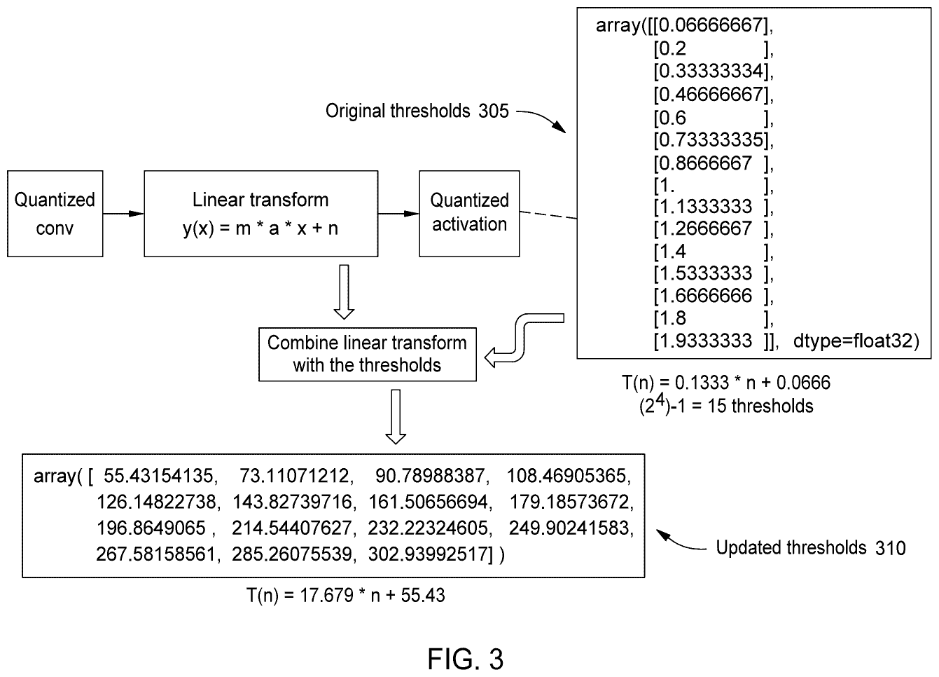

FIG. 3 illustrates that the calculations performed by the linear transform layer 205 in FIG. 2 can be absorbed into the thresholds used to perform quantization. That is, in FIG. 3, the quantization thresholds for the activation layer 120 are updated by absorbing the values of the floating-point multiple-add operations that were performed in the linear transform layer 205 in FIG. 2. Now, performing quantization at the layer 120 performs both the linear transform as well as quantization. This is based on the observation that having a stair step threshold comparison with a linear function that scales and adds to the input of the quantization activation, the linear transform can be removed entirely by updating the value of the thresholds.

FIG. 3 illustrates that the parameters of the linear transform are used to change the original thresholds 305 (that were also shown in FIGS. 1 and 2) to generate the updated thresholds 310. Nonetheless, the updated quantization thresholds 310 are still linear but are expressed using a different linear equation: T(n)=17.679*n+55.43.

However, the original thresholds 305 and the updated thresholds 310 are expressed as floating-point values. These values can be simplified further by exploiting the knowledge that our inputs are integers and simply round-up the updated floating-point thresholds to the nearest integer, as shown in FIG. 4. In one embodiment, this is a mathematically equivalent operation and introduces no accuracy degradation relative to the quantization activation in FIGS. 1-3. Unlike their original floating-point counterparts though, the rounded thresholds 405 are no longer an arithmetic sequence with a strictly uniform step size. This is due to the non-linear nature of the rounding operation. Put differently, the thresholds shown in FIG. 4 are now non-linear quantization thresholds and cannot be expressed using a linear equation.

Without the embodiments described below, because the rounded thresholds 405 are non-linear, this would mean they have to be stored in memory rather than being calculated on the fly (or as needed) using a linear equation. However, as discussed above, storing the rounded thresholds in memory requires a lot of memory space.

The memory space required to store the quantization thresholds grows exponentially with the bit-width of quantized activations. For 8-bit quantized activations, the implied memory cost for storing 255 thresholds can be quite significant. As one example, using 8-bit activation quantization with per-channel floating-point scale factors can be larger than the storage required for NN weights. On one hand, rounding the thresholds to generate integers is advantageous since the input is also integers, but it comes at a cost of potentially having to store the thresholds.

The embodiments below permit the use of the rounded (integer) thresholds but greatly minimize the storage penalty of having non-linear thresholds. The bottom half of FIG. 4 further illustrates a relationship between the rounded threshold 405 where the difference between two neighboring thresholds (i.e., the delta between two sequential thresholds) is either 18 or 17. As such, the thresholds can be described as “near-uniform” in that the difference/delta between the thresholds is offset by at most a value of 1. This is referred to as a residual or a residual error. Specifically, even though the rounded thresholds are no longer spaced strictly uniformly and the distances between consecutive ones are no longer a single unique (floating-point) constant d, every delta can still only assume one of two (integer) values: the original scaling factor rounded down (D) or rounded up (D+1). Any two deltas are either equal or differ by one. The quantized thresholds still observe a near-uniform spacing. The difference between two consecutive thresholds is always either 17 or 18.

This small and known residual error can be leveraged to generate thresholding logic to calculate the thresholds on the fly, rather than having to store the thresholds explicitly in memory. That is, the fact that rounding the thresholds results in non-linear thresholds does not mean it is impractical to use thresholding logic to calculate the thresholds. Different examples of thresholding logic for use with non-linear, near-uniform thresholds are described in the figures that follow.

FIG. 5 illustrates thresholding logic 500 for sequentially calculating monotonic, non-decreasing thresholds, according to one embodiment herein. The left side of FIG. 5 illustrates calculating the deltas between sequential thresholds 405 (the same as shown in FIG. 4). This can be used to generate a delta array 550. Moreover, FIG. 5 illustrates generating an offset array 555 from the delta array 550 where each value in the offset array 555 indicates the residual or residual error between an actual delta and the baseline delta, here assumed to be the minimum rounded-down delta of D. If a value in the delta array 550 is D (here: 17), its corresponding residual value in the offset array 555 is zero; if it is D+1 (here: 18), its corresponding residual value in the offset array 555 is one. Advantageously, the offset array 555 uses very little memory/storage since it is an array of one-bit values (e.g., 2\hat{ }2−2) that stores the residual errors on top of the baseline delta D between consecutive thresholds.

The thresholding logic 500 includes circuitry for sequentially calculating the thresholds 405. As shown, the logic 500 includes a shift register 505 that stores the offset array 555, a step register 510 that stores the step (or minimum delta value) between the thresholds, an accumulation register 515 for storing the previous calculated threshold, and a base register 520 for storing the initial threshold. When an input is received (e.g., when the quantized convolution layer 105 in FIG. 4 passes a value to the quantized activation layer 120), it is compared to the first threshold of the thresholds 405. That is, the value in the base register (56 in this example) is stored in the accumulator register 515 and compared against the input value. If the input value is greater than the initial value (i.e., the first threshold), the thresholding logic 500 calculates the next threshold by adding to the first value in the shift register (e.g., the first bit in the offset array 555) to the value in the step register (e.g., 17). The next threshold value (i.e., 56+1+17=74) is stored in the accumulator register 515 and compared to the input value. If the input value is greater than the second threshold, the thresholding logic 500 calculates the next threshold by adding to the second value in the shift register (e.g., the second bit in the offset array 555) to the value in the step register (e.g., 17) to calculate the third threshold (i.e., 74+0+17=91). This process can continue until the shift register is out of values or before a comparator (not shown) in the thresholding logic 500 determines that the threshold has grown beyond the input value.

The thresholding logic 500 can maintain a count or index of the number of times it has incremented a threshold. For example, if the input value is greater than the fourth threshold but less than the fifth threshold, the thresholding logic 500 can return the value of 4 (or 5 depending on the implementation) to the next layer which identifies which quantization value should be used to perform the next layer in the NN. If the values are equal, the implementation can choose which side to follow.

Moreover, while FIG. 5 illustrates starting from the first threshold and sequentially increasing the thresholds, in another embodiment, the initial value could be the last/largest threshold and the thresholding logic could sequentially reduce the threshold using the offset array 555 and the step register 510 to determine the threshold that is less than the input value.

With the parameters illustrated in FIG. 5, the thresholds 405 can be economically recovered by a sequential computation, e.g. with a thresholding logic 500. In this example using k=4 bit quantized activations, a shift register O of width 1 and depth 2\hat{ }k−2=14 is used to store the residuals in the array 555. At every clock cycle, the value of the delta D (i.e., the step value) is added to the next residual bit from the shift register to produce the value of the next threshold. This is suitable for a small hardware implementation that has tight footprint constraints, but has the trade-off that ˜2\hat{ }k clock cycles are required to compute all the thresholds and finish the quantization operation for a single element. For small k e.g. binary, ternary or 4-bit quantization, this is still a favorable trade-off, but gets more expensive for larger values of k.

Although the operations can be parallelized across different tensor elements by duplicating the hardware, the intrinsic latency involved in quantizing a single element can be still relatively high if k is larger, e.g. ˜255 cycles for 8-bit quantization.

FIG. 5 illustrates an implementation of thresholding logic 500 where, for per-channel scaling, the computing system only has to store an offset array 555 storing 1-bit values, a step value (e.g., the minimum delta value), and an initial value for each channel. As the thresholding logic processes input values for different channels, it can retrieve these values from memory and calculate the thresholds on the fly, without having to store the thresholds in memory (besides temporarily storing each threshold in the accumulator register 515). This greatly reduces the memory storage relative to storing all the thresholds (which includes at least 15 8-bit values) for each channel in memory.

However, one disadvantage of the thresholding logic 500 is that in the worst case scenario (when the input value is greater than the last threshold (e.g., the 15^{th} threshold), the logic 500 has to calculate all the thresholds (i.e., it does not exit early). Thus, while the thresholding logic 500 has very little circuitry (e.g., only one comparator and the logic shown in FIG. 5) it might offer slow performance, especially for applications where the input values are often at the higher threshold values. FIG. 6 offers a tradeoff of using more circuitry but offering better performance in those situations.

FIG. 6 illustrates thresholding logic 600 for calculating monotonic, non-decreasing thresholds for a binary search tree 601, according to an example. That is, the thresholding logic 600 can include circuitry that implements the binary search tree 601 shown in FIG. 6. In FIG. 6, the different nodes of the search tree represent 15 different quantization thresholds (T0-T14). The @ symbols are memory address that store residual errors R, which are similar to the residual errors stored in the offset array 555 in FIG. 5. However, while the offset array 555 described the error or residual between two consecutive deltas, in FIG. 6 the residual errors represent the offset between deltas for thresholds that may not be consecutive. For example, at address @2, the system stores the residual error between the threshold T7 and T3 while address @3 stores the residual error between the threshold T7 and T11. Because these thresholds are not sequential, the system stores multiple bits (5 in this example) rather than just one bit as in the offset array 555 in FIG. 5. Using the thresholds 405 in FIG. 5 as examples, these bits can indicate the number of the deltas between thresholds T7 and T3 (or between T7 and T11) that are 18 or 17. If the value stored in the five bits @2 is a 0, this could mean all the deltas are 17 while the maximum value could mean all the deltas are 18. The values in between the minimum and maximum value can represent a mix of deltas (e.g., a value of one could mean one 17 delta and three 18 deltas, etc.). In this manner, the bits stored at address @2 store the residuals between the deltas of the thresholds T7-T3.

Notably, the residual errors reduce as you move down the binary tree because the distance between the thresholds in the two levels shrinks. That is, the residual error between the thresholds T3 and T1 is stored at memory address @4 and is three bits. Further, the residual error between the thresholds T1 and T0 is stored at memory address @8 and is only on bit (because the thresholds T1 and T0 are consecutive thresholds). Thus, in FIG. 6, the thresholding logic 600 uses more memory space to store the residual errors versus the offset array 555 in FIG. 5, but also searching a binary tree can take less time since it uses four cycles, rather than the maximum (possible) 15 cycles for the sequential method described in FIG. 5.

To provide an example of how the binary tree is traversed, assume the input value is between thresholds T2 and T3. The input value is first compared to the threshold value T7. Thus, like in FIG. 5, an initial value is stored in memory. While that initial value for the thresholding logic 500 in FIG. 5 was the first threshold (or could be the last threshold), here it is the median threshold T7.

Because the input value is less than T7, a comparator (c) outputs a 0. The thresholding logic 600 then uses this value (i.e., c=0) to select which of the two threshold equations 605 to use to calculate the next threshold (i.e., T3). In this case, the lower threshold equation 605 is selected where T is the value of the current threshold (T7), M is the integer threshold distance (which is the same as the step value discussed in FIG. 5), l is the current level of the binary tree (0 in this case) and R is the residual error (the 5-bit residual error stored at address @2). From this, the threshold calculates the value of the of the threshold T3 which is compared to the input value at the comparator.

Because the input value is less than T3, the comparator again outputs a 0.The thresholding logic 600 then uses this value (i.e., c=0) to again select the lower threshold equation 605 to use to calculate the next threshold (i.e., T1). In this case, T is the value of the current threshold (T3), M is the integer threshold distance which is a constant, l is the current level of the binary tree (1 in this case) and R is the residual error (the 3-bit residual error stored at address @4). From this, the threshold calculates the value of the of the threshold T1 which is compared to the input value at the comparator.

Because the input value is greater than T1, the comparator outputs a 1. The thresholding logic 600 then uses this value (i.e., c=1) to select the upper threshold equation 605 to use to calculate the next threshold (i.e., T2). In this case, T is the value of the current threshold (T1), M is the integer threshold distance which is a constant, l is the current level of the binary tree (2 in this case) and R is the residual error (the 1-bit residual error stored at address @9). From this, the threshold calculates the value of the of the threshold T2 which is compared to the input value at the comparator. The comparator determines the input value is greater than T2 and returns this index value to the next layer, similar to the output of the thresholding logic 500.

Thus, if per-channel scaling is desired, the system stores in memory the integer threshold distance M, the initial threshold (T7 in this example), and the residual errors. Again, the amount of memory being used to store the residual errors may be more than used to store the offset array 555 in FIG. 5, but FIG. 6 has the advantage of identifying the index for the appropriate threshold in four cycles rather than the maximum of 15 it may take for FIG. 5. Further, the thresholding logic 600 can be pipelined (assuming there are four comparators rather than just one) so that while the thresholding logic 600 is comparing a first input value to threshold T7, the logic 600 can also be comparing a second input to either T3 or T11 (the second layer of the binary tree), a third input to either T1, T5, T9, or T13 (the third layer of the binary tree), and a fourth input to either T0, T2, T4, T6, T8, T10, T12, or T14 (the fourth layer of the binary tree).

The higher-performance thresholding logic 600 provides parallel access to the to the distance array and an unrolled adder network. The tight bound of 1 for the deviation of the distance between consecutive (sequential) thresholds from D naturally generalizes to distances between arbitrary thresholds yielding T_j−T_i=(j−i) * D+r_(i,j) with 0<=r_(i,j)<=j−i. This finding can be exploited by the above mentioned binary search. At the cost of additional compute for calculating the next needed threshold, the word size in the local memories of the pipeline stages can be reduced significantly as shown in FIG. 6. Note that the reduction to a single bit is possible along half of the edges, towards the leaf nodes of the underlying binary search tree 601. With each level up approaching the root, the distance between the relevant thresholds and, hence, the bound for its residue doubles, each time demand another bit in memory word width. However, that this is still significantly smaller than storing threshold values at the input precision of 20+ or even 30+ bits. Finally, note that the threshold derivation in this case is anchored at the median threshold (e.g., T7), which is stored together with the lower-bound integer distance in the first pipeline stage, which represents D the root of the search tree.

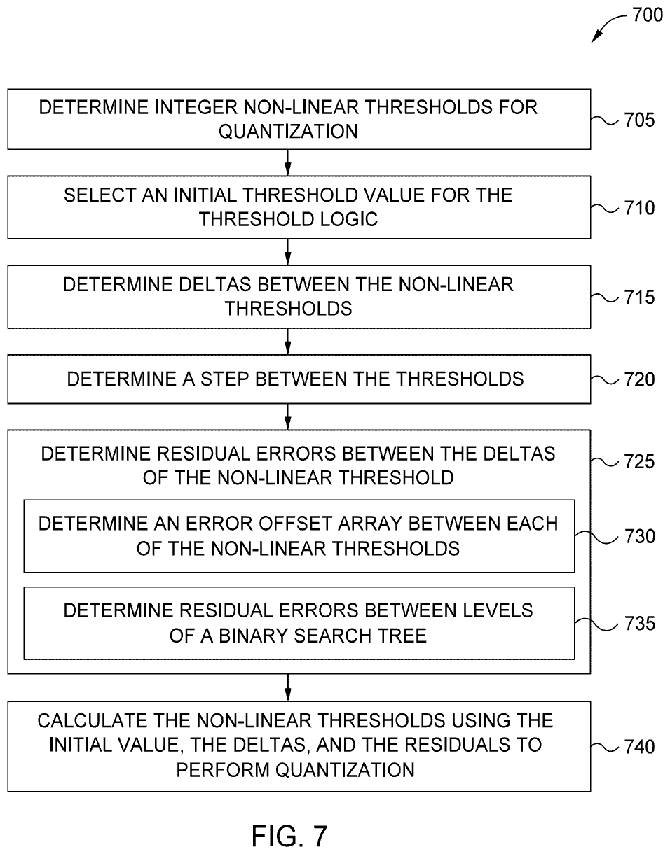

FIG. 7 is a flowchart of a method 700 for determining values for calculating monotonic, non-decreasing thresholds for quantization, according to an example. In one embodiment, the blocks shown in method 700 are performed by a compiler. For example, the method 700 may be performed after a NN has been trained. More specifically, the method 700 may be performed after NN training where the updated thresholds 310 shown in FIG. 3 have been identified, which represent a combination of the original thresholds 305 and the linear transform.

At block 705, the compiler determines integer non-linear thresholds for quantization. In one embodiment, the compiler rounds the updated (floating point) thresholds 310 shown in FIG. 3 to generate rounded, non-linear thresholds such as the thresholds 405 in FIG. 4. However, the embodiments herein are not limited to any particular technique or reason for having non-linear thresholds. Put differently, the embodiments herein can be used for any application that wants to compare an input to non-linear thresholds, without having to store those thresholds in memory.

In any case, the method 700 uses the example of performing quantization using the thresholds. Further, assuming a per-channel scale is desired, the method 700 may be repeated for each channel.

At block 710, the compiler selects an initial threshold value for the thresholding logic. If using the thresholding logic 500 in FIG. 5, the initial value is the first threshold (or the last threshold) of the non-linear thresholds. As discussed there, the thresholding logic 500 iterates through the thresholds, starting at the first threshold. However, if using the thresholding logic 600 in FIG. 6, the initial value is the middle or median threshold, which is used as the root node of the binary search tree 601.

At block 715, the compiler determines deltas between the non-linear thresholds. If using the thresholding logic 500 in FIG. 5, this includes identifying the difference or delta between each sequential or consecutive threshold. If using the thresholding logic 600 in FIG. 6, this includes identifying the delta between two thresholds in two levels of the binary tree (e.g., between T7 and T3 and between T7 and T11).

At block 720, the compiler determines a step size between the thresholds. In one embodiment, this step size is a minimum delta value of the delta values calculated at block 715. In FIG. 5, the step size is stored in the step register 510 (e.g., a step size register). In FIG. 6, the step size is the integer threshold distance (M) which is bit shifted according to the current level (l) of the binary search tree.

At block 725, the compiler determines residual errors between the deltas identified at block 715 using the step size determined at block 720. The block 725 includes two different sub-block that describe two different types of residual errors (or different ways of determining the residual errors).

If using the thresholding logic 500 in FIG. 5, at sub-block 730 the compiler determines an error offset array (of 1-bit values) where each bit represents a difference between the deltas of two consecutive thresholds. For example, the residual errors are stored in the offset array of one-bit values where each bit value represents a residual error between the delta value between consecutive thresholds and the step size.

If using the thresholding logic 600 in FIG. 6, at sub-block 735 the compiler determines residual errors between deltas of thresholds in different levels of the binary search tree (e.g., a combination of the residuals of the deltas between thresholds T7 and T3, a combination of the residuals of the deltas between thresholds T7 and T11, and so forth). In this example, the residual errors correspond to the difference between the delta between two thresholds with a link in a binary search tree and a step size multiple of their index difference implemented by the thresholding logic At block 740, the compiler calculates the non-linear thresholds using the initial value determined at block 710, the residuals determined at block 725, and the step size determined at block 720 to perform quantization. That is, thresholding logic can receive and input value and compare it to the thresholds (e.g., using the logic shown in FIG. 5 or 6) to identify one of the thresholds. The input can then be assigned to the threshold, or the index of that threshold can be passed to the next layer in a NN for further processing.

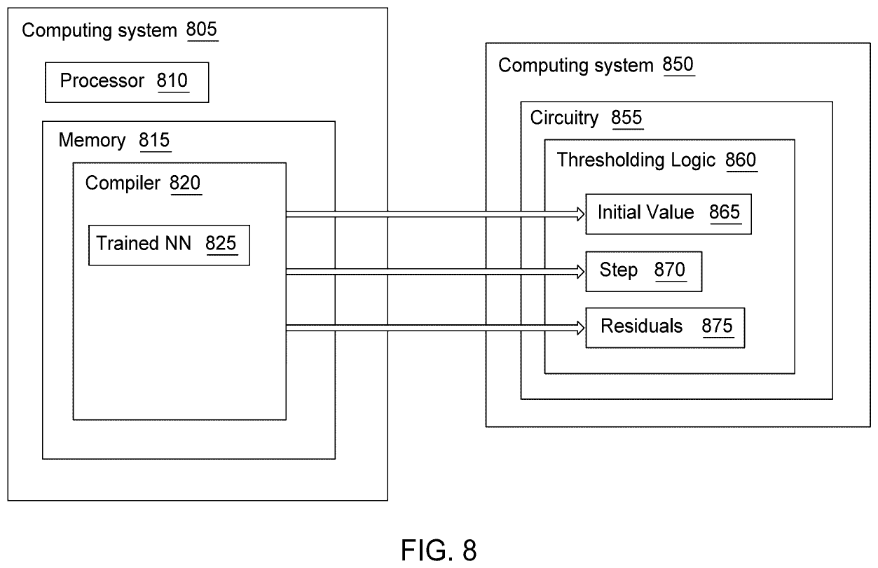

FIG. 8 is a block diagram of computing systems, according to an example. The computing system 800 includes a processor 805 and memory 815. The computing system 800 can be implemented as a single computing device (e.g., a server) or a system of multiple computing devices (e.g., interconnected servers or cards).

The processor 810 can represent any different type of processing element such as a central processing unit (CPU), a graphics processing unit (GPU), an application specific integrated circuit (ASIC), and the like. The processor 810 can represent any number of processors (either the same type of processor or different types of processors) where each processor has any number of processing cores.

The memory 815 can include volatile memory elements, non-volatile memory elements, and combinations thereof. The memory 815 stores a compiler 820 (e.g., which can perform the method 700 in FIG. 7) which receives as an input a trained NN 825. The compiler 820 compiles the trained NN 825 so it can run or execute on the computing system 850.

The computing system 850 includes circuitry 855 that implements the thresholding logic 860 (which could be the thresholding logic 500 in FIG. 5 or the thresholding logic 600 in FIG. 6). The thresholding logic 860 receives an initial value 865, a step size 870, and residuals 875. For example, the compiler 820 may compute the initial value 865 using block 710 of FIG. 7, compute the step size 870 using block 735 of FIG. 7, and compute the residuals using block 720 of FIG. 7. With these values, the thresholding logic 860 can calculate non-linear thresholds which can be compared with inputs as part of, for example, a quantization operation.

For example, the computing system 850 may be a low power computing device, or a computing device with fewer compute resources (e.g., a consumer device, an internet of things (IoT) device, an edge device, etc.). These devices may use smaller output values (smaller values of k), which makes the embodiments herein ideal for reducing the memory requirements corresponding to the quantization thresholds.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more non-transitory computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A system comprising:
one or more processors; and
memory configured to store a compiler, the compiler configured to perform an operation comprising:
providing non-linear thresholds associated with a quantization operation;
selecting an initial threshold value for thresholding logic configured to perform the quantization operation;
determining delta values indicating respective differences between two thresholds of the non-linear thresholds, wherein at least two of the delta values are different;
determining a step size from the delta values;
determining residual errors between the delta values based on the step size; and
transmitting the initial threshold value, residuals, and step size to the thresholding logic for performing the quantization operation.

2. The system of claim 1, wherein the residual errors are differences between at least two of the delta values.

3. The system of claim 1, wherein the step size is minimum delta value of the delta values.

4. The system of claim 1, wherein the delta values are one of only two values.

5. The system of claim 1, wherein the operation further comprises:
rounding floating point thresholds that are linear to generate the non-linear thresholds, wherein the non-linear thresholds are integers.

6. The system of claim 1, wherein the quantization operation is part of a neural network layer.

7. The system of claim 1, wherein the residual errors are stored in an offset array of one-bit values where each bit value represents a residual error between the delta value between consecutive thresholds and the step size.

8. The system of claim 7, wherein the thresholding logic comprises a shift register for combining one of the bit values in the offset array with the step size stored in a step size register and the initial threshold value stored in a base register.

9. The system of claim 8, wherein the thresholding logic further comprises an accumulator register for storing a current threshold of the non-linear threshold, wherein the thresholding logic sequentially calculates the non-linear thresholds using the shift register, the step size register, the base register, and the accumulator register.

10. The system of claim 1, wherein the residual errors correspond to the difference between the delta between two thresholds with a link in a binary search tree and a step size multiple of their index difference implemented by the thresholding logic.

11. The system of claim 10, wherein the initial threshold value is a median threshold of the non-linear thresholds and corresponds to a root node of the binary search tree.

12. The system of claim 10, wherein the thresholding logic is configured to compare different inputs to thresholds in different levels of the binary search tree in parallel.

13. A non-transitory computer readable medium storing instructions that, when executed by a combination of one or more processors, cause the combination of one or more processors to perform an operation comprising:
providing non-linear thresholds associated with a quantization operation;
selecting an initial threshold value for thresholding logic configured to perform the quantization operation;
determining delta values indicating respective differences between two thresholds of the non-linear thresholds, wherein at least two of the delta values are different;
determining a step size from the delta values;
determining residual errors between the delta values based on the step size; and
transmitting the initial threshold value, residuals, and step to the thresholding logic for performing the quantization operation.

14. The non-transitory computer readable medium of claim 13, wherein the residual errors are differences between the delta values and the step size.

15. The non-transitory computer readable medium of claim 13, where the delta values are one of only two values.

16. A computing system comprising:
circuitry comprising thresholding logic configured to:
store an initial threshold value for the thresholding logic;
store residual errors between delta values and a step size, the delta values indicating respective differences between two thresholds from a set of non-linear thresholds, wherein at least two of the delta values are different;
store the step size between the set of non-linear thresholds; and
calculate the set of non-linear thresholds using the initial threshold value, the residual errors, and the step size.

17. The computing system of claim 16, wherein the residual errors are stored in an offset array of one-bit values where each bit value represents a residual error between the delta value between two consecutive thresholds of the non-linear thresholds and the step size.

18. The computing system of claim 17, wherein the thresholding logic comprises a shift register for combining one of the bit values in the offset array with the step size stored in a step size register and the initial threshold value stored in a base register.

19. The computing system of claim 16, wherein the residual errors correspond to the difference between the delta between two thresholds with a link in a binary search tree and a step size multiple of their index difference implemented by the thresholding logic.

20. The computing system of claim 19, wherein the initial threshold value is a median threshold of the non-linear thresholds and corresponds to a root node of the binary search tree.
